(19) United States
(12) Patent Application Publication
(10) Pub. No.: US 2007/0046493 A1
(43) Pub. Date: Mar. 1, 2007

(54) Home appliance control apparatus and method

(75) Inventors: Ki-su Park, Seoul (KR); Young-man Kim, Seoul (KR); Yong-hwan Kang, Incheon Metropolitan (KR); Jong-woo Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/502,372

(22) Filed: Aug. 11, 2006

(30) Foreign Application Priority Data
Aug. 26, 2005 (KR) 10-2005-0078851

(51) Int. Cl. G08C 19/00

(52) U.S. Cl. 340/825.69; 340/825.24; 455/420

(57) ABSTRACT

A home appliance control apparatus and method. The apparatus includes a wireless phone signal reception unit, a search unit, a home appliance control signal generation unit, and a network interface unit. The wireless phone signal reception unit receives a wireless phone signal from the handset of a wireless telephone set, and extracts key information contained in the wireless phone signal. The search unit searches a home appliance control command mapped to the extracted key information. The home appliance control signal generation unit generates a home appliance control signal, including the found home appliance control command. The network interface unit transmits the generated home appliance control signal.

### CROSS-REFERENCE TO RELATED APPLICATION

This application claims priority from Korean Patent Application No.10-2005-0078851 filed on Aug. 26, 2005 in the Korean Intellectual Property Office, the disclosure of which is incorporated herein by reference in its entirety.

### BACKGROUND OF THE INVENTION

1. Field of the Invention

Apparatuses and methods consistent with the present invention relate to home appliance control and, more particularly, to controlling home appliances within a home network by using a wireless telephone set.

2. Description of the Related Art

Generally, a home network that connects various home appliance products such as a television (TV), a refrigerator and an air conditioner, which are located in a master bedroom, kitchen and living room, respectively, is realized through a common virtual computing environment.

In such a case, the common virtual computing environment enables communication between various digital devices that are connected in a peer-to-peer manner by implementing various networking technologies and standards such as home A/V interoperability (HAVI), universal plug-and-play (UPnP), JINI (a Java network technology), and home-wide-web (HWW).

In such a home network environment, a user can remotely control the home appliances provided within a home while the user is away from the home. For example, the user can control the operation of a washing machine while the user is located in master bedroom, or the user can control the opening and closing of the front door while the user is located in the kitchen, or the user can operate an air conditioner while located outside the home.

In such a home network environment, a control terminal (hereinafter referred to as a “home appliance control terminal”), such as a personal digital assistant (PDA) or a “WebPad,” is used by the user to control the home appliances. The home appliance control terminal can communicate with a home appliance control apparatus, such as a home server, that controls a home network through a gateway. Accordingly, when the user controls a certain home appliance by using the home appliance control terminal, a command corresponding to the operation performed by the user is transmitted to the home appliance control apparatus. The home appliance control apparatus then outputs a control signal corresponding to the received command to the selected home appliance, thereby controlling the operation of the home appliance.

However, elderly and middle-aged people, who occupy a considerable percentage of home network users, are generally unfamiliar with the use of home appliance control terminals, such as PDAs or “WebPads.” Accordingly, a technology for allowing users to easily interface with home networks to control home appliances is desired.

### SUMMARY OF THE INVENTION

In view of the above, an aspect of the present invention provides a method and an apparatus for easily controlling home appliances which are connected to a home network by using a wireless telephone.

An aspect of the present invention provides a home appliance control apparatus, including a wireless phone signal reception unit for receiving a wireless phone signal from a handset of a wireless telephone set, and extracting key information contained in the wireless phone signal; a search unit for searching a home appliance control command mapped to the extracted key information; a home appliance control signal generation unit for generating a home appliance control signal, including the found home appliance control command; and a network interface unit for transmitting the generated home appliance control signal.

An aspect of the present invention also provides a home appliance control method, including receiving a wireless phone signal from a handset of a wireless telephone set; and transmitting a home appliance control signal corresponding to key information contained in the received wireless phone signal.

### BRIEF DESCRIPTION OF THE DRAWINGS

The aspects of the present invention will be more clearly understood from the following detailed description of exemplary embodiments thereof taken in conjunction with the accompanying drawings, in which:

FIG. 1 is a diagram showing a home appliance control system, according to an exemplary embodiment of the present invention;

FIG. 2 is a diagram showing a process of controlling a home appliance, according to an exemplary embodiment of the present invention;

FIG. 3 is a block diagram showing the construction of a home appliance control apparatus, according to an exemplary embodiment of the present invention;

FIG. 4 is a block diagram showing the construction of a handset of a wireless telephone set, according to an exemplary embodiment of the present invention;

FIG. 5 is a flowchart illustrating a process of editing mapping information between home appliance control commands and key information, according to an exemplary embodiment of the present invention;

FIG. 6 is a flowchart illustrating a home appliance control method, according to an exemplary embodiment of the present invention; and

FIG. 7 is a flowchart illustrating a home appliance control method, according to another exemplary embodiment of the present invention.

### DESCRIPTON OF EXEMPLARY EMBODIMENTS OF THE PRESENT INVENTION

The advantages and characteristics of the present invention, and exemplary methods and apparatuses for achieving them, will be apparent with reference to exemplary embodiments thereof described in detail below in conjunction with accompanying drawings. However, the present invention is not limited to the exemplary embodiments disclosed below, but may be implemented in various ways. Furthermore, the exemplary embodiments of the present invention are provided merely by way of illustration to assist those skilled in the art in understanding the present invention as defined by the appended claims. The same reference numerals are used throughout the drawings to designate the same or similar components.

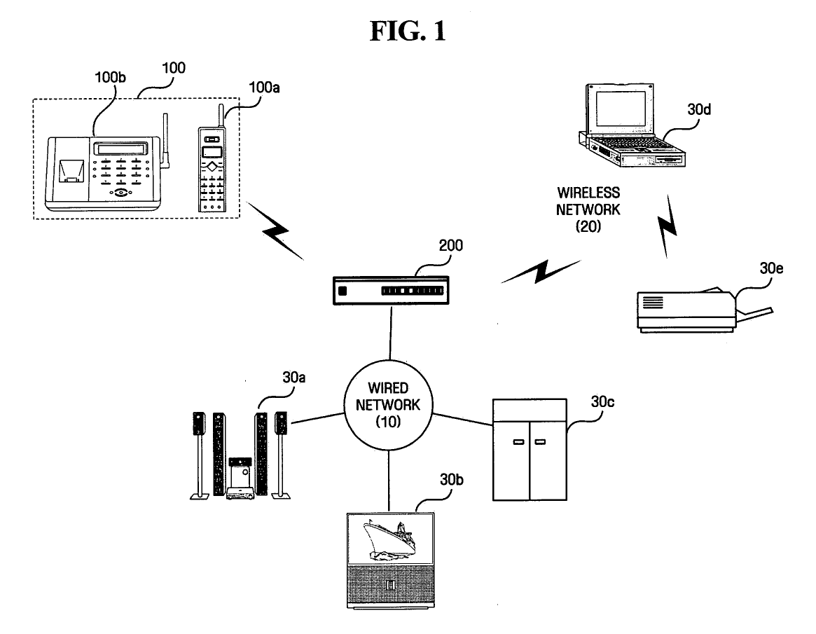

FIG. 1 is a diagram showing a home appliance control system, according to an exemplary embodiment of the present invention.

The home appliance control system, as shown in FIG. 1, includes a wireless telephone set 100, a home appliance control apparatus 200, and one or more home appliances 30a, 30b, 30c, 30d and 30e.

The wireless telephone set 100 is a telephone for conducting communication, like a wired telephone set, and includes a base 100b and a handset 100a The base 100b is connected to a telephone line, and the base 100b and the handset 100a transmit and receive voice and data signals using radio frequency (RF) signals. Accordingly, the wireless telephone set 100 can be referred to as a cordless phone (CLP). A user can make a phone call using the handset 100a within a predetermined distance from the base 100b. Meanwhile, according to an exemplary embodiment of the present invention, the user can control the home appliances 30a, 30b, 30c, 30d and 30e by inputting predetermined key information using alphanumeric buttons (for example, the ‘*’ button and the ‘#’ button) provided in the handset 100a.

The home appliance control apparatus 200 forms a wired network 10 or a wireless network 20 together with the home appliances 30a, 30b, 30c, 30d and 30e. For example, the home appliance control apparatus 200 forms a network with the home appliances 30a, 30b, 30c, 30d and 30e using a wired communication protocol, such as Institute of Electrical and Electronics Engineer (IEEE) 1394, power line communication (PLC) or phone line networking alliance (PNA), or using a wireless communication protocol, such as Infrared Data Association (IrDA), wireless local area network (WLAN), wireless personal area network (WPAN) or Bluetooth.

Furthermore, the home appliance control apparatus 200 has a function of receiving a wireless phone signal that is transmitted from the handset 100a, and analyzing the received signal. Accordingly, the home appliance control apparatus 200 transmits a home appliance control signal, which corresponds to key information that is contained in the wireless phone signal received from the handset 100a, to a corresponding home appliance. For this purpose, the home appliance control apparatus 200 may store mapping information between home appliance control commands and key information. The mapping information may be initially set to a default value and may be edited by the user. The home appliance control apparatus 200 may be connected a gateway or a home network server.

The various types of the home appliances 30a, 30b, 30c, 30d and 30e that can be used consistent with the present invention are not limited, and the home appliances 30a, 30b, 30c, 30d and 30e may be any of various apparatuses, such as a cleaning machine, an air conditioner, a TV, a computer, an entry/exit door controller and a gas valve controller, that are commonly used in a home. Furthermore, the home appliances 30a, 30b, 30c, 30d and 30e can communicate with the home appliance control apparatus 200 via a wireless or a wired connection, can receive home appliance control signals from the home appliance control apparatus 200, respectively, and can perform corresponding operations according to the home appliance control signals. Hereinafter, the home appliances 30a, 30b, 30c, 30d and 30e are collectively designated by a reference numeral ‘30’.

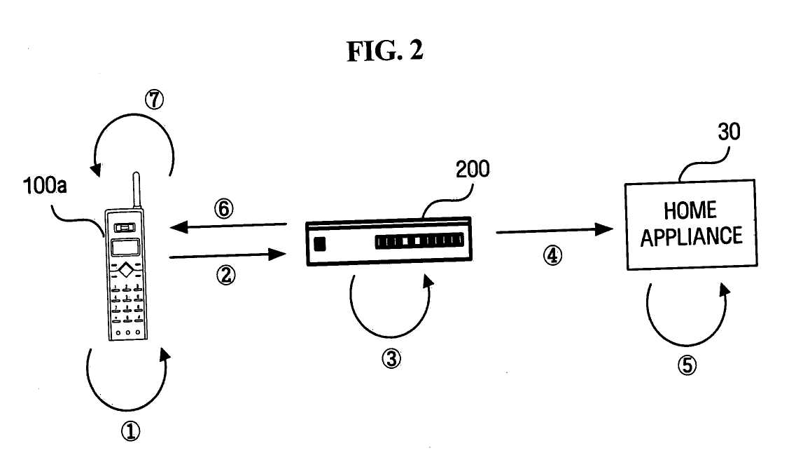

A process of controlling home appliances by a home appliance control system consistent with an exemplary embodiment of the present invention is described below with reference to FIG. 2.

FIG. 2 is a diagram showing a process of controlling a home appliance, according to an exemplary embodiment of the present invention.

First, a user inputs key information, which corresponds to the operation of a home appliance 30 to be controlled, through the alphanumeric buttons provided in the handset 100a (operation \textcircled{1}). For example, the key information can be a combination of numbers, symbols, and characters.

The handset 100a then transmits a wireless phone signal, including the key information that is input by the user (operation (\textcircled{2}).

The home appliance control apparatus 200, which has received the wireless phone signal transmitted from the handset 100a, extracts the key information contained in the wireless phone signal, and generates a home appliance control signal corresponding to the key information (operation \textcircled{3}).

Thereafter, the home appliance control apparatus 200 transmits the home appliance control signal to the home appliance 30, that is, a target appliance to be controlled (operation \textcircled{4}), and then the home appliance 30 receives the transmitted signal and performs an operation according to the transmitted signal (operation \textcircled{5}).

Meanwhile, in the case where the extracted key information corresponds to a request for mapping information between home appliance control commands and key information, the home appliance control apparatus 200 may transmit a wireless phone signal, including the mapping information that has been stored therein, to the handset 100a (operation \textcircled{6}). In this case, the handset 100a may extract the mapping information from the wireless phone signal received from the home appliance control apparatus 200, and display the extracted mapping information to be viewed the user (operation \textcircled{7}). Accordingly, the user can view the mapping information between the home appliance control commands and the key information. Additionally, the user can view the mapping information between the home appliance control commands and the key information while directly manipulating the home appliance control apparatus 200.

The home appliance control apparatus and the handset according to an exemplary embodiment of the present invention are described in detail below.

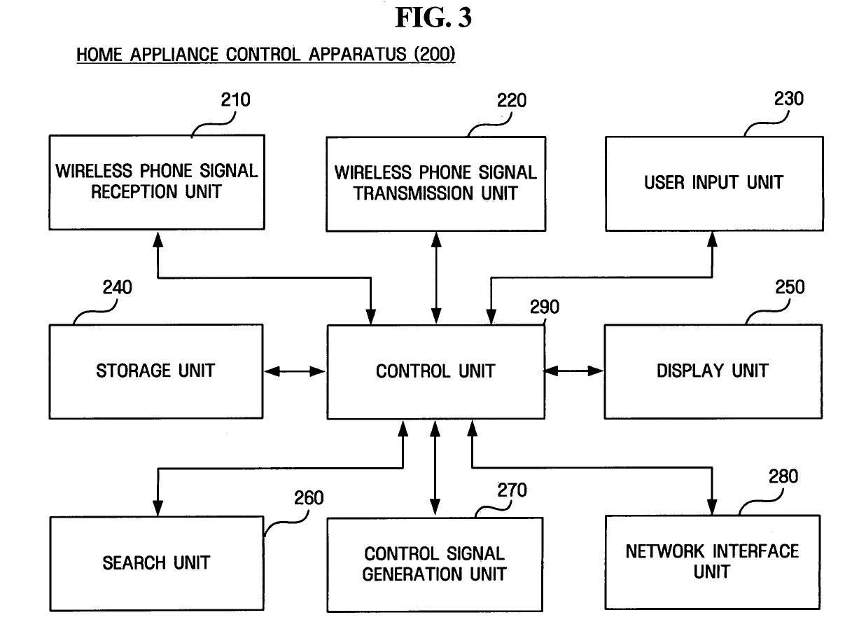

FIG. 3 is a block diagram showing the construction of a home appliance control apparatus, according to an exemplary embodiment of the present invention.

The home appliance control apparatus 200, as shown in FIG. 3, includes a wireless phone signal reception unit 210, a wireless phone signal transmission unit 220, a user input unit 230, a storage unit 240, a display unit 250, a search unit 260, a control signal generation unit 270, a network interface unit 280, and a control unit 290.

The wireless phone signal reception unit 210 receives the wireless phone signal transmitted from the handset 100a, and demodulates the received wireless phone signal. According to the exemplary embodiment shown in FIG. 3, the wireless phone signal reception unit 210 can extract the key information contained in wireless phone signal. For this purpose, the wireless phone signal reception unit 210 may use a frequency identical to the transmission frequency used by the handset 100a.

The wireless phone signal transmission unit 220 modulates data to be transmitted to the handset 100a, sets the transmission frequency of the modulated data, and outputs the modulated data. Thus, the wireless phone signal transmission unit 220 can transmit the wireless phone signal, including the modulated data. For this purpose, the wireless phone signal transmission unit 220 may use a frequency identical to the transmission frequency used by the base 100b of the wireless telephone 100.

The user input unit 230 receives a control request or key information from the user. For this purpose, the user input unit 230 is provided with an input means, such as a keypad, a touchpad, or a touchscreen, for example. According to an exemplary embodiment of the present invention, the user can edit the mapping information between the home appliance control commands and the key information through the user input unit 230.

The storage unit 240 stores the mapping information between the home appliance control commands and the key information. According to an exemplary embodiment, the mapping information is initially set to default values. When the user edits the mapping information through the user input unit 230, the edited mapping information is stored in the storage unit 240. According to an exemplary embodiment, the key information may include at least one of numbers and symbols. Preferably, but not necessarily, the key information includes at least one symbol. Accordingly, when the user manipulates the alphanumeric buttons to make a general phone call using the handset 100a, a home appliance control request to the home appliance control apparatus 200 can be prevented.

The display unit 250 displays the mapping information between the home appliance control commands and the key information, which is stored in the storage unit 240, at the request of the user. For this purpose, the display unit 250 may be implemented using a display means, such as a liquid crystal display, a plasma display panel (PDP), or an organic electro-luminescent (EL) display, for example. One example of the mapping information displayed by the display unit 250 is represented in Table 1.

TABLE 1

| Control | Home appliance | Key |
|---|---|---|
| target appliance | control commands | information |
| Air conditioner | Air conditioner ON | #01 |
| | Air conditioner OFF | #02 |
| Front door | Close | #11 |
| | Open | #12 |
| | Mapping Information | #00 |
| | Request | |

According to an exemplary embodiment of the present invention, the user can edit the mapping information through the user input unit 230 while viewing the mapping information displayed on the display unit 250.

Referring to FIG. 3 again, the search unit 260 searches the storage unit 240 for a home appliance control command that has been mapped to the key information extracted from the wireless phone signal received by the wireless phone signal reception unit 210.

The control signal generation unit 270 generates a home appliance control signal, including the home appliance control command found by the search unit 260.

The network interface unit 280 transmits the control signal generated by the control signal generation unit 270 to the home appliance 30. For this purpose, the network interface unit 280 forms a network with the home appliances 30a, 30b, 30c, 30d and 30e using a wired communication protocol, such as IEEE 1394, PLC or PNA, or using a wireless communication protocol, such as Infrared Data Association (IrDA), WLAN, WPAN or Bluetooth. Furthermore, the network interface unit 280 may include one or more sub-interface units (not shown) to support a plurality of communication protocols.

The control unit 290 controls the operation of functional blocks 210,220,230,240,250,260, 270 and 280 that constitute the home appliance control apparatus 200.

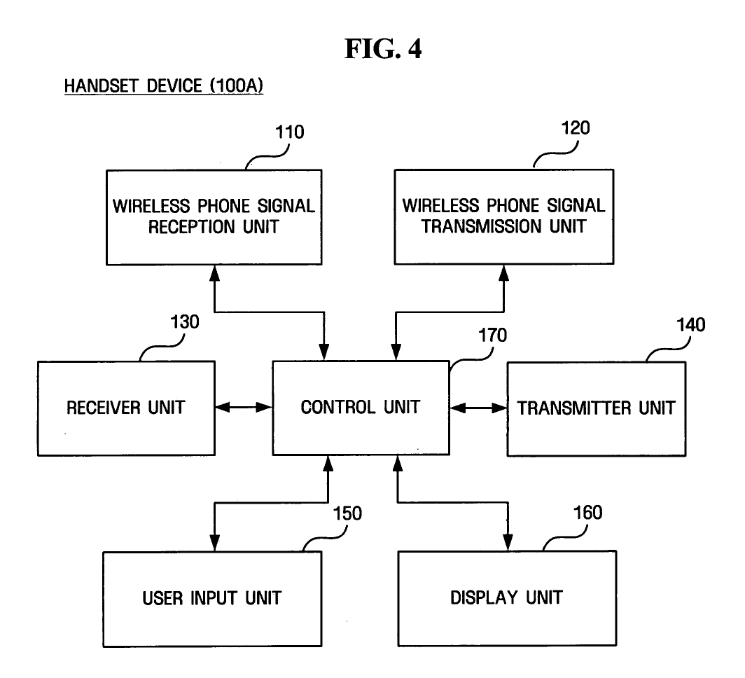

FIG. 4 is a block diagram showing the construction of a handset device of a wireless telephone, according to an exemplary embodiment of the present invention.

The exemplary handset device 100a, as shown in FIG. 4, includes a wireless phone signal reception unit 110, a wireless phone signal transmission unit 120, a control unit 170, and a display unit 160.

The wireless phone signal reception unit 110 receives a wireless phone signal transmitted from the home appliance control apparatus 200, and demodulates the received wireless phone signal. According to an exemplary embodiment, the wireless phone signal reception unit 110 can extract the mapping information between the home appliance control command and the key information, which is contained in the wireless phone signal. Furthermore, the wireless phone signal reception unit 110 receives a wireless phone signal transmitted from the base 100b, and demodulates the received wireless phone signal. According to an exemplary embodiment, the wireless phone signal reception unit 110 can extract a voice signal contained in the wireless phone signal received from the base 100b. For this purpose, the wireless phone signal reception unit 110 may use a frequency identical to a transmission frequency used by the base 100b.

The wireless phone signal transmission unit 120 demodulates the voice signal, which is transferred from a transmitter unit 140, or the key information, which is transferred from the user input unit 150, sets the transmission frequency of the modulated signal, and outputs the demodulated voice signal or the key information, respectively. Thus, the wireless phone signal transmission unit 120 can transmit the wireless phone signal, including the voice signal or the key information. The transmission frequency used by the wireless phone signal transmission unit 120 is the same as the reception frequency used by the wireless phone signal reception unit 210 of the home appliance control apparatus 200 and the base 100b.

The receiver unit 130 outputs the voice signal extracted by the wireless phone signal reception unit 110. For this purpose, the receiver unit 130 may be provided with, for instance, a speaker for outputting the voice signal.

The transmitter unit 140 electrically converts sounds input by the user, and generates a voice signal. For this purpose, the transmitter unit 140 may be provided with, for example, a microphone.

The user input unit 150 receives key information from the user. The key information may include, for example, numbers or symbols. For this purpose, the user input unit 150 may be provided with an input means, such as a keypad, a touchpad or a touchscreen for example.

The display unit 160 displays numbers or symbols input through the user input unit 150. Furthermore, the display unit 160 displays the mapping information between the home appliance control command and the key information, which is extracted by the wireless phone signal reception unit 110 from the wireless phone signal received from the home appliance control apparatus 200. For this purpose, the display unit 160 may be implemented using a display means, such as a LCD, a PDP, or an organic EL display, for example.

The control unit 170 controls the overall operations of respective functional blocks 110, 120, 130, 140, 150 and 160 comprising the handset 100a

The functional blocks referred to as “units” in FIGS. 3 and 4, may be implemented using a module. The term “module” refers to, but is not limited to, a software or hardware component, such as a field programmable gate-array (FPGA) or an application-specific integrated circuit (ASIC), which performs certain tasks. The module may advantageously be configured to reside on an addressable storage medium and may be configured to be executed on one or more processors. Thus, the module may include, by way of example, components, such as software components, object-oriented software components, class components and task components, processes, function, attributes, procedures, subroutines, segments of program code, drivers, firmware, microcode, circuitry, data, databases, data structures, tables, arrays, and variables. Functions provided by components and modules may be combined into fewer components and modules or further separated into additional components and modules.

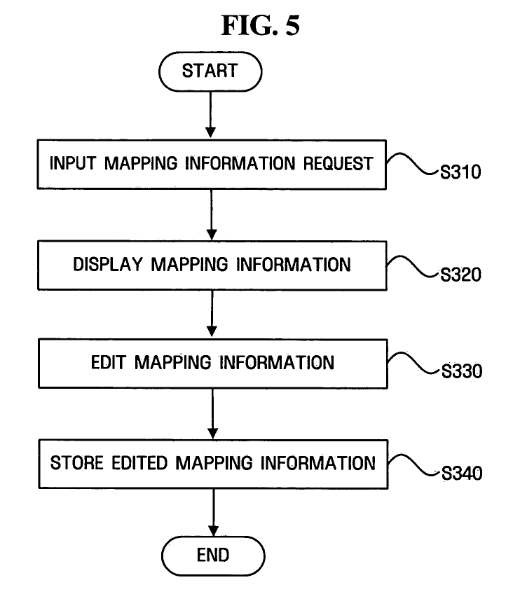

FIG. 5 is a flowchart illustrating a process of editing mapping information between the home appliance control commands and the key information, according to an exemplary embodiment of the present invention. The flowchart shown in FIG. 5 shows operations performed by the home appliance control apparatus 200.

First, the input unit 230 receives a request for the mapping information between home appliance control commands and key information from a user at operation S310, the display unit 260 displays the mapping information between the home appliance control commands and the key information, which has been stored in the storage unit 240, at operation S320. For example, such displayed mapping information has already been described above with reference to Table 1.

In the case where the mapping information between the home appliance control commands and the key information is first displayed, the mapping information may display default values previously set on the home appliance control apparatus 200. However, when the user edits the mapping information, the mapping information that has last been edited by the user is displayed.

Thereafter, at operation S330, the user may edit the mapping information through the user input unit 230 so that key information, for instance, a combination of desired numbers and symbols, is mapped according to a specific home appliance control command received. Once the mapping information is edited, the user can select the specific home appliance control command through the user input unit 230, and input key information, which will be mapped to the selected home appliance control command.

According to the exemplary embodiment shown in FIG. 5, the storage unit 240 stores the edited mapping information at operation S340.

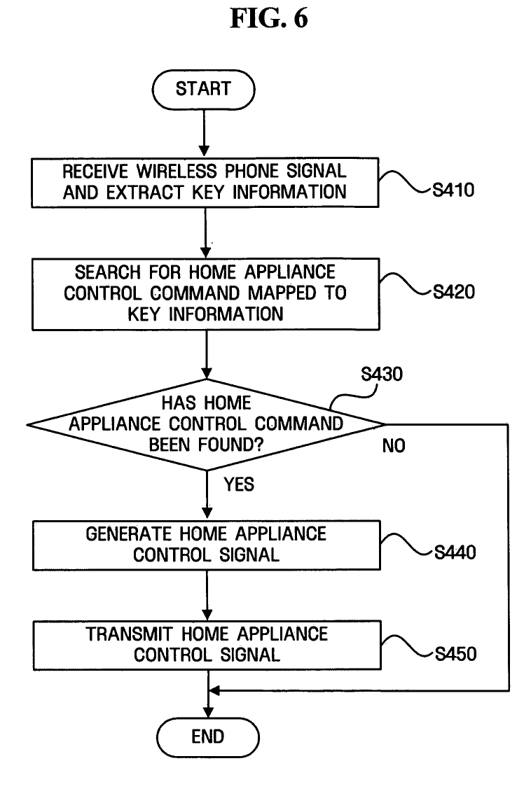

FIG. 6 is a flowchart illustrating a home appliance control method according to an exemplary embodiment of the present invention.

When a user desiring to control a home appliance inputs predetermined key information through the user input unit 150 of the handset 100a, the wireless phone signal transmission unit 120 of the handset 100a transmits a wireless phone signal, including the inputted key information.

According to an exemplary embodiment of the present invention, when the wireless phone signal reception unit 210 of the home appliance control apparatus 200 receives the wireless phone signal transmitted from the handset 100a and extracts the key information contained in the received wireless phone signal at operation S410, the search unit 270 searches the storage unit 240 for a home appliance control command that is mapped to the extracted key information at operation S420.

If the home appliance control command has been found at operation S430, the control signal generation unit 280 generates the home appliance control signal, including the found home appliance control command at operation S440.

Thereafter, the network interface unit 290 transmits the home appliance control signal to the target appliance to be controlled, at operation S450.

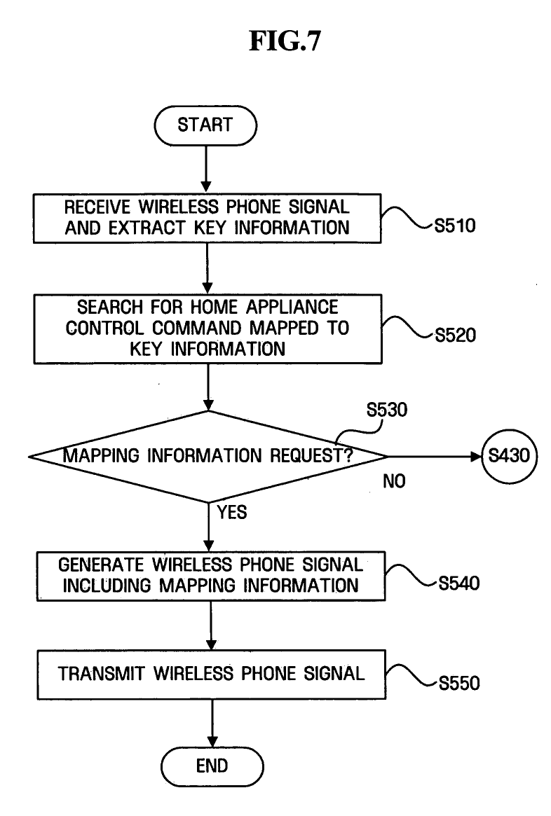

Meanwhile, according to an exemplary embodiment of the present invention, the user may view the mapping information between the home appliance control commands and the key information stored in the home appliance control apparatus 200 through the handset 100a, as described below with reference to FIG. 7.

FIG. 7 is flowchart illustrating a home appliance control method according to another exemplary embodiment of the present invention.

When the wireless phone signal reception unit 210 of the home appliance control apparatus 200 receives a wireless phone signal transmitted from the handset 100a, and extracts key information contained in the received wireless phone signal at operation S510, the search unit 270 searches the storage unit 240 for a home appliance control command mapped to the extracted key information at operation S520.

At operation S530, when the home appliance control command, which is found by the search unit 270, corresponds to a mapping information request, the wireless phone signal transmission unit 220 generates a wireless phone signal at operation S540, including the mapping information between the home appliance control command and the key information, which are stored in the storage unit 240 and then transmits the generated wireless phone signal at operation S550.

For example, in the case where the mapping information shown in Table 1 has been stored in the storage unit 240, when the user inputs the key information “#00” through the handset 100a, then the handset 100a transmits a wireless phone signal, including key information “#00.” According to this exemplary embodiment, the home appliance control apparatus 200 receives the transmitted signal and extracts the key information “#00.” In Table 1, the key information “#00” has been mapped to a home appliance control command indicated by “mapping information request.’” Accordingly, the home appliance control apparatus 200 can generate the wireless phone signal, including the mapping information of Table 1, and transmit the generated signal to the handset 100 Consistent with this exemplary embodiment, the user can view the mapping information, which has been stored in the home appliance control apparatus 200, through the display unit 160 of the handset 100a

Meanwhile, when, at operation S530, the key information does not correspond to a mapping information request, operations S430, S440 and S450 of FIG. 6 can be performed.

As described above, in accordance with exemplary embodiments of the present invention, a home network can be easily controlled using the handset of the wireless telephone.

Although the exemplary embodiments of the present invention have been described above for illustrative purposes, those skilled in the art will appreciate that various modifications, additions and substitutions are possible to the exemplary embodiments of the present invention, without departing from the scope and spirit of the invention as defined by the accompanying claims.

What is claimed is:

1. An appliance control apparatus comprising:
a wireless phone signal reception unit which receives a wireless phone signal from a handset of a wireless telephone set, and which extracts key information contained in the wireless phone signal;
a search unit which searches for an appliance control command that is mapped to the extracted key information;
an appliance control signal generation unit which generates an appliance control signal, wherein the appliance control signal includes a found appliance control command; and
a network interface unit which transmits the generated appliance control signal.

2. The appliance control apparatus of claim 1, further comprising:
a storage unit which stores mapping information comprising an association between an appliance control command and key information; and
a wireless phone signal transmission unit which transmits the mapping information to the handset of the wireless telephone set when the extracted key information comprises a mapping information request.

3. The appliance control apparatus of claim 2, further comprising:
a user input unit which receives a user's request; and
a display unit which displays the mapping information after the user's request is received by the user input unit.

4. The appliance control apparatus of claim 3, wherein the mapping information stored in the storage unit is edited after the user's request is received by the user input unit.

5. The appliance control apparatus of claim 1, wherein the key information includes at least one of numbers and symbols.

6. The appliance control apparatus of claim 1, wherein the network interface unit uses a wired communication protocol or a wireless communication protocol.

7. The appliance control apparatus of claim 6, wherein the wired communication protocol is any one of power line communication (PLC), Phone line Networking Alliance (PNA), and Institute of Electrical and Electronics Engineers (IEEE) 1394.

8. The appliance control apparatus of claim 6, wherein the wireless communication protocol is any one of infrared communication, wireless local area network (WLAN), wireless personal area network (WPAN), and Bluetooth.

9. An appliance control method comprising:
receiving a wireless phone signal from a handset of a wireless telephone set; and
transmitting an appliance control signal corresponding to key information contained in the received wireless phone signal.

10. The appliance control method of claim 9, wherein transmitting the appliance control signal further comprises:
extracting the key information contained in the received wireless phone signal;
searching for an appliance control command that is mapped to the extracted key information;
generating the appliance control signal, wherein the generated appliance control signal includes a found appliance control command; and
transmitting the generated appliance control signal.

11. The appliance control method of claim 9, further comprising transmitting mapping information comprising an association between an appliance control command and a piece of key information to the handset of the wireless telephone set.

12. The appliance control method of claim 9, wherein the key information includes at least one of numbers and symbols.

13. The appliance control method of claim 9, wherein the appliance control signal is transmitted using a wired communication protocol or a wireless communication protocol.

14. The appliance control method of claim 13, wherein the wired communication protocol is any one of PLC, PNA, and EEE 1394.

15. The appliance control method of claim 13, wherein the wireless communication protocol is any one of infrared communication, WLAN, WPAN, and Bluetooth.
